(19) United States
(12) Patent Application Publication
(10) Pub. No.: US 2025/0280203 A1
(43) Pub. Date: Sep. 4, 2025

(54) APPARATUS AND METHOD FOR EXAMINING LENS FLARE

(71) Applicant: Luritech Co., Ltd., Anyang-si (KR)

(72) Inventors: Hye Kwang KIM, Anyang-si (KR); Sun Jin KIM, Anyang-si (KR); Min Seo CHOI, Gunpo-si (KR); Young Jun YOOK, Seongnam-si (KR); Chan Ho PARK, Suwon-si (KR); Wook HEO, Seoul (KR)

(73) Assignee: Luritech Co., Ltd., Anyang-si (KR)

(21) Appl. No.: 19/004,112

(22) Filed: Dec. 27, 2024

(30) Foreign Application Priority Data
Feb. 29, 2024 (KR) 10-2024-0029660
Apr. 29, 2024 (KR) 10-2024-0056927

(51) Int. Cl. H04N 23/71; H04N 23/55; H04N 23/72; H04N 23/75; H04N 23/76

(52) U.S. Cl. CPC H04N 23/71; H04N 23/72; H04N 23/75; H04N 23/76; H04N 23/55

(57) ABSTRACT

An apparatus for examining a lens flare according to one aspect of the present disclosure includes a camera module fixing part fixing a camera module to be examined to an examination position, an optical part radiating one or more spot lights to various positions on a lens of the camera module from above the camera module, and an image processing part examining a lens flare in an image obtained through the camera module fixed on the camera module fixing part, thereby examining a lens flare. The image processing part generates a flare mask based on a brightness value to remove a portion of the image corresponding to the mask, and then compares reference values obtained using a median brightness value for each first angle of a circle formed based on a center of the flare and the overall median brightness value to determine a light scattering angle.

### CROSS-REFERENCE TO RELATED APPLICATION(S)

This application claims priority from Korean Patent Application No. 10-2024-0029660, filed on Feb. 29, 2024, and Korean Patent Application No. 10-2024-0056927, filed on Apr. 29, 2024 in the Korean Intellectual Property Office, the disclosure of which is incorporated herein by reference in its entirety.

### BACKGROUND

### 1. Field

The present disclosure relates to an apparatus for examining a camera module, and more particularly, to a lens examination technology for detecting a flare, i.e., a light scattering phenomenon, that occurs due to a strong spot light source.

### 2. Description of Related Art

When a strong light source, especially a spot light source, is shone on a lens of a camera module, a lens flare is formed in an image captured by the camera module. When manufacturing a camera module, as lens examination, there is a process of shining a spot light source to artificially generate flares and checking whether a light scattering phenomenon occurs in the corresponding flares in an image.

Conventionally, such a lens defect examination process is performed manually, and there have been problems with the time taken for the examination and the lack of consistency in the examination.

There is a need for a method of automatically examining whether light scattering has occurred from an image of a flare caused by a spot light source.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The present disclosure is directed to providing a flare examination technology that can, from an image including a flare artificially generated using a spot light source, analyze an image of the flare and automatically judge a light scattering defect of a lens.

One aspect of the present disclosure provides an apparatus for examining a lens flare, the apparatus including a camera module fixing part, an optical part, and an image processing part. The camera module fixing part fixes a camera module to be examined to an examination position. The optical part includes a light source part, one or more light radiating parts, and a mounting part, the light source part generates light and outputs the light through an optical cable, the light radiating parts condense light input through the optical cable connected to the light source part and radiates spot light, and the mounting part mounts the one or more light radiating parts on an upper portion of the camera module fixing part such that the spot light radiated by the light radiating parts reaches a lens of the camera module.

The image processing part examines a lens flare in an image obtained through the camera module fixed on the camera module fixing part. The image processing part may include one or more processors and a memory storing program instructions executable by the processors.

According to an additional aspect of the present disclosure, the optical part may further include an adjusting part adjusting positions of the light radiating parts mounted on the mounting part and adjusting light radiation directions of the light radiating parts.

Specifically, according to one aspect of the present disclosure, the light radiating parts may each include a fastening part fastened to the optical cable to receive light, a light condensing part including one or more light condensing lenses spaced a predetermined distance from the fastening part and condensing light input through the fastening part, and a light output part outputting the condensed light.

At this time, the optical part may further include a pin hole part coupled to the light output part to allow the light to be output in a circular shape or a polygonal shape.

According to one aspect, a method for examining a flare that is implemented by a program run by an image processing part of the present disclosure includes a flare mask generating step, a flare mask applying step, a median brightness value calculating step, and a light scattering judging step.

The flare mask generating step is a step of detecting a flare based on a pixel brightness from an image to be examined and generating a flare mask in an area having a brightness value greater than or equal to a first threshold value set according to a maximum brightness value of pixels in the flare.

The flare mask applying step is a step of extracting a light scattering examination area having a circular shape of a set first diameter size from the image to be examined and applying the flare mask.

The median brightness value calculating step is a step of obtaining a median brightness value of fan shapes each having a first angle set based on a center of the light scattering examination area, wherein the median brightness value of the fan shapes each having the first angle is obtained based on 360° while the fan shapes each having the first angle rotate without overlapping.

The light scattering judging step is a step of judging an angle at which the median brightness value of the fan shapes each having the first angle exceeds a light scattering reference value as an angle where light scattering is present.

Specifically, the flare mask generating step includes a maximum brightness value calculating step of obtaining a maximum brightness value of pixels in the image to be examined and a mask generating step of generating the flare mask in an area where the brightness value is greater than or equal to the set first threshold value, and the flare mask applying step includes a flare center determining step of determining a center of the detected flare, an examination area extracting step of, based on the determined center of the flare, extracting the light scattering examination area in the circular shape of the set first diameter size from the image to be examined, and a mask applying step of applying the flare mask on the extracted light scattering examination area so that a brightness of the area of the mask becomes 0.

According to an additional aspect of the present disclosure, the method may further include an image cropping step, and the image cropping step is a step of, from an image capturing one or more spot light sources, generating the image to be examined by cropping an image area including the flare based on a set region-of-interest (ROI).

According to an additional aspect of the present disclosure, the method may further include a light scattering reference value setting step, and the light scattering reference value setting step is a step of obtaining the median brightness value of all the fan shapes each having the first angle and then multiplying the median brightness value by a set second threshold value to set the light scattering reference value.

According to an additional aspect of the present disclosure, the flare mask generating step of the method may further include a first threshold value setting step, and the first threshold value setting step is a step of setting the first threshold value by multiplying the maximum brightness value by a scale factor set to a value less than 1.

According to an additional aspect of the present disclosure, the flare mask generating step of the method may further include a blurring step of, before the generating of the mask, using a median filter to blur the image to be examined.

According to an additional aspect of the present disclosure, the method may further include a black-and-white image conversion step of converting the image to be examined into a black-and-white image.

Other features and aspects will be apparent from the following detailed description, the drawings, and the claims.

### BRIEF DESCRIPTION OF THE DRAWINGS

FIG. 1 is a block diagram of an apparatus for examining a lens flare according to one aspect of the present disclosure.

FIG. 2 is an exemplary perspective view of an optical part of the apparatus for examining a lens flare according to the present disclosure.

FIG. 3 is an exemplary top view of the optical part of the apparatus for examining a lens flare according to the present disclosure.

FIG. 4 is an exemplary view of a light radiating part of the apparatus for examining a lens flare according to the present disclosure.

FIG. 5 is an exemplary view of the light radiating part to which an adjusting part is coupled.

FIG. 6A and FIG. 6B are conceptual views of connection between a light source part and the light radiating part of the apparatus for examining a lens flare according to the present disclosure.

FIG. 7 is an exemplary view of a configuration of the light radiating part of the apparatus for examining a lens flare according to the present disclosure.

FIG. 8A and FIG. 8B are exemplary views of a concept that a distance between a fastening part and a light condensing part of the light radiating part changes.

FIG. 9 is a flowchart of a method for examining a flare according to one aspect of the present disclosure.

FIG. 10 is a flowchart of a method for examining a flare according to an additional aspect of the present disclosure.

FIG. 11 illustrates a concept of generating an image to be examined in the method for examining a flare.

FIG. 12 illustrates a concept of generating a flare mask in the method for examining a flare according to one aspect of the present disclosure.

FIG. 13 illustrates a concept of generating the flare mask after applying a median blur according to an additional aspect of the present disclosure.

FIG. 14 illustrates a concept of applying the flare mask in the method for examining a flare.

FIG. 15 illustrates a concept of setting a light scattering reference value in the method for examining a flare.

FIG. 16A and FIG. 16B illustrate a concept of judging light scattering in the method for examining a flare.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The above-described aspects and additional aspects are embodied through embodiments described with reference to the accompanying drawings. It will be understood that components of each of the embodiments may be combined in various ways within one embodiment unless otherwise stated or there is a contradiction between them. In some cases, each block in a block diagram may represent a physical part, and in other cases, each block in the block diagram may be a logical representation of a portion of a function of one physical part or may be a logical representation of a function across a plurality of physical parts. In some cases, a block or an entity of a portion of a block may be a set of program instructions. All or some of the blocks may be implemented in hardware, software, or a combination thereof.

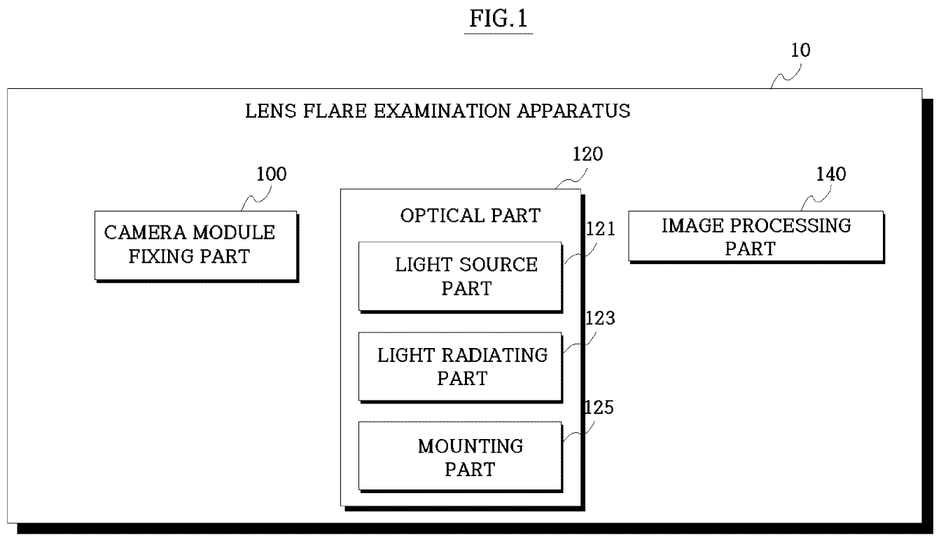

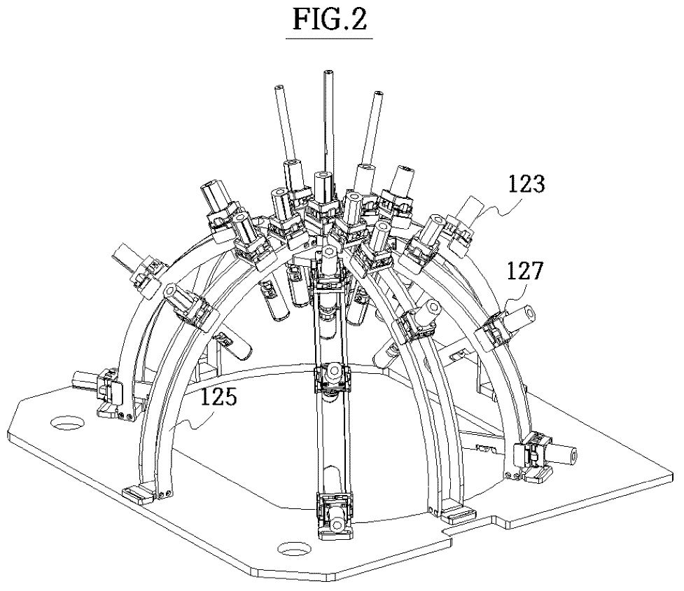

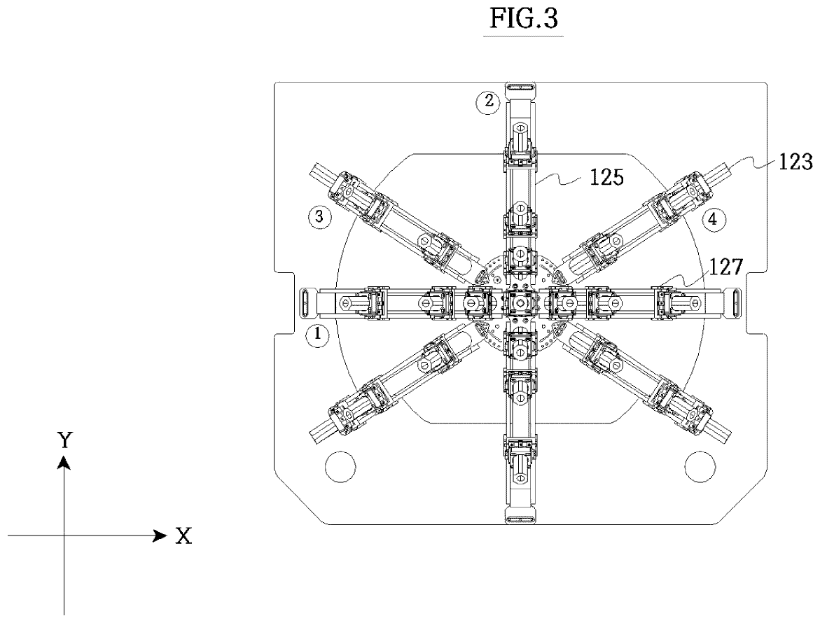

FIG. 1 is a block diagram of an apparatus for examining a lens flare according to one aspect of the present disclosure, FIG. 2 is an exemplary perspective view of an optical part of the apparatus for examining a lens flare according to the present disclosure, and FIG. 3 is an exemplary top view of the optical part of the apparatus for examining a lens flare according to the present disclosure.

A lens flare examination apparatus 10 according to one aspect of the present disclosure includes a camera module fixing part 100, an optical part 120, and an image processing part 140.

The lens flare examination apparatus 10 is an apparatus for examining a flare and examining where there is a defect in a lens for a camera module assembled by a camera module assembly apparatus. According to aspects of the disclosure, the lens flare examination apparatus 10 may be configured as a part of the camera module assembly apparatus or may be configured as a separate examination apparatus after assembly.

The camera module fixing part 100 moves after a camera module to be examined is mounted thereon and fixes the camera module to an examination position.

The optical part 120 includes a light source part 121, one or more light radiating parts 123, and a mounting part 125. In FIGS. 2 and 3, the light source part of the optical part 120 is not illustrated, and the optical part 120 is illustrated as having a hemispherical shape as a whole, but the present disclosure is not limited thereto. The optical part 120 is located at an upper portion of the camera module mounted on the camera module fixing part 100 so that one or more spot lights reach various positions on a lens of the camera module. By the optical part 120 having a hemispherical shape as a whole, there may be almost no variation or only a slight difference in distances at which spot lights radiated by the light radiating parts 123 mounted on the mounting part 125 reach the lens, that is, a distance between each of the light radiating parts 123 and the lens.

The light source part 121 generates and outputs light through a light emitting diode (LED) or a laser diode. For example, the light source part 121 may output light having a color temperature of 3,500 K and luminance of 1,600,000 lux. According to aspects of the disclosure, one or more light source parts 121 may be used.

As in the optical part 120 illustrated in FIGS. 2 and 3, one or more light radiating parts 123 may be included. The light radiating parts 123 condense light input from the light source part 121 and radiate spot light toward the lens of the camera module. For example, 25 light radiating parts 123 may be included as illustrated in FIG. 3, but this is only illustrative, and the number of included light radiating parts 123 may vary. In addition, although all of the light radiating parts 123 included in the optical part 120 may radiate spot light, depending on specifications (e.g., an angle of view) of the lens of the camera module to be examined, only some of the light radiating parts 123 may be controlled to radiate spot light. An increase in the number of light radiating parts 123 may cause difficulty in hemispherical arrangement thereof. According to an additional aspect, the optical part 120 may further include an optical cable guiding light output from the light source part to the light radiating parts.

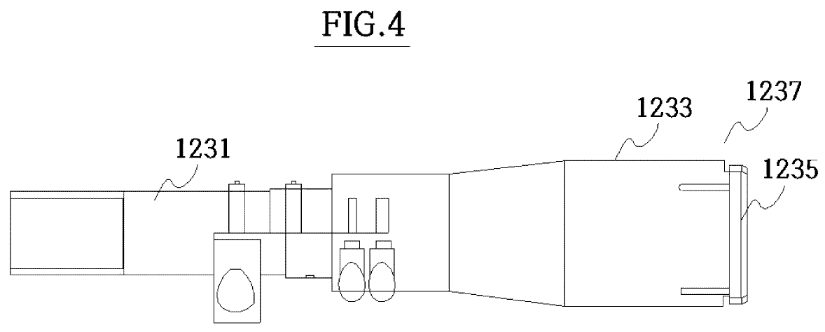

FIG. 4 is an exemplary view of a light radiating part of the apparatus for examining a lens flare according to the present disclosure. The light radiating part 123 includes a fastening part 1231, a light condensing part 1233, and a light output part 1235.

The fastening part 1231 receives light through the optical cable having one end connected to the light source part 121 and the other end inserted into and fastened to the fastening part 1231.

The light condensing part 1233 includes one or more light condensing lenses spaced a predetermined distance from the fastening part 1231 and condensing light input through the optical cable fastened to the fastening part 1231. The light condensing part 1233 condenses light generated by the light source part 121 and transmitted through the optical cable and generates spot light.

The light output part 1235 is a portion located on the opposite side of the 10) fastening part to output the condensed spot light to the outside.

In addition, the optical part 120 may further include a pin hole part 1237.

The pin hole part 1237 is coupled to the light output part 1235 to allow the light to be output in a circular shape or a polygonal shape. The pin hole part 1237 reduces an area through which the spot light condensed by the light condensing part 1233 reaches the lens and allows the shape of the light to be circular or polygonal more clearly.

According to aspects of the disclosure, the pin hole part 1237 may be detachably coupled to the light radiating parts 123.

The mounting part 125 mounts the one or more light radiating parts 123 on an upper portion of the camera module fixing part such that the spot light radiated by the light radiating parts reaches the lens of the camera module. The mounting part 125 is illustrated in FIGS. 2 and 3, and particularly, in FIG. 3, mounting parts 125 are provided in X-axis and Y-axis directions (1 and 2) and diagonal directions (3 and 4) to mount the light radiating parts 123. The light radiating parts 123 may be moved as necessary and may be mounted by being arranged along the mounting parts 125.

The image processing part 140 examines a lens flare in an image obtained through the camera module fixed on the camera module fixing part 100.

The image processing part 140 is a separate apparatus including one or more processors and a memory storing program instructions executable by the processors. The image processing part 140 may be a computer apparatus that, in addition to the processors and the memory, further includes a graphic processor unit (GPU), a storage device, a display, an input device, etc. The processors are processors executing program instructions, and the memory is connected to the processors and stores program instructions executable by the processors, data to be used by the processors in an arithmetic operation, data processed by the processors, etc.

The image processing part 140 is an apparatus performing an algorithm of examining a lens flare image and detecting a defect in the lens.

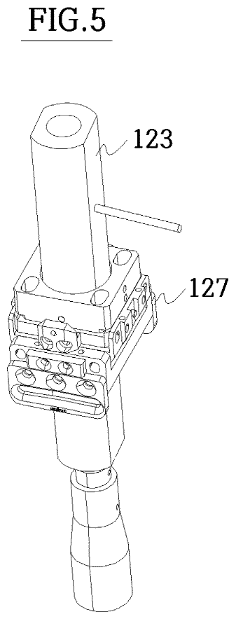

FIG. 5 is an exemplary view of the light radiating part to which an adjusting part is coupled. According to an additional aspect of the present disclosure, the optical part 120 may further include an adjusting part 127.

The adjusting part 127 may adjust positions of the light radiating parts 123 mounted on the mounting part 125 and may adjust light radiation directions of the light radiating parts 123. The adjusting part 127 may adjust the positions of the light radiating parts along the X-axis, Y-axis, and Z-axis and may tilt the positions in the X-axis and Y-axis directions to perform five-axis adjustment. In particular, the adjusting part 127 may adjust the positions along the Z-axis to adjust an examination distance, that is, a distance between the light radiating parts 123 and the camera module.

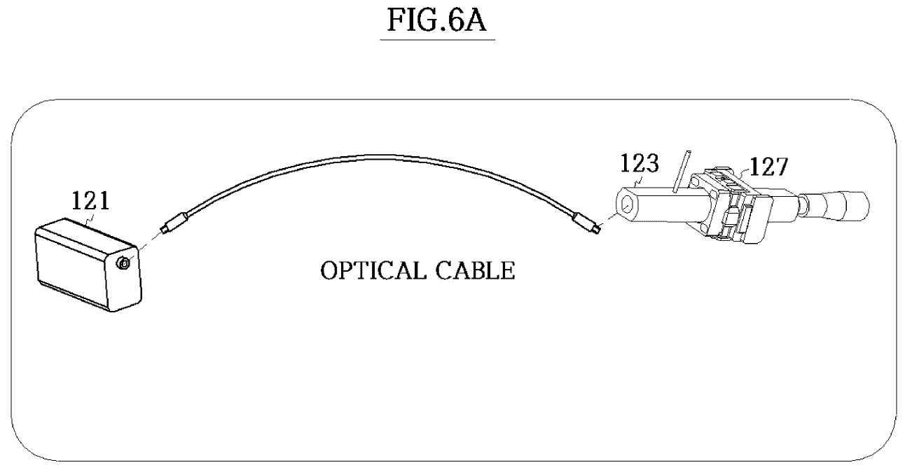

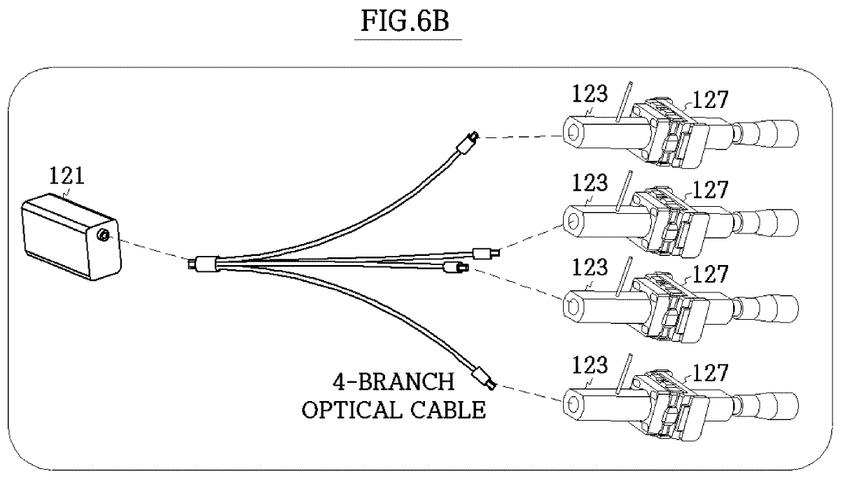

FIG. 6A and FIG. 6B are conceptual views of connection between a light source part and the light radiating part of the apparatus for examining a lens flare according to the present disclosure. FIG. 6A illustrates a case in which the light source part 121 and the light radiating part 123 are connected one-to-one through an unbranched optical cable, and FIG. 6B illustrates a case in which a single light source part 121 is connected to four light radiating parts 123 through a 4-branch optical cable.

For example, when the optical part 120 includes 25 light radiating parts 123, 7 light source parts 121 may be used, one light source part 121 may be connected to one light radiating part 123 through an unbranched optical cable, and the other light source parts 121 may be connected to 4 light radiating parts 123 through a 4-branch optical cable.

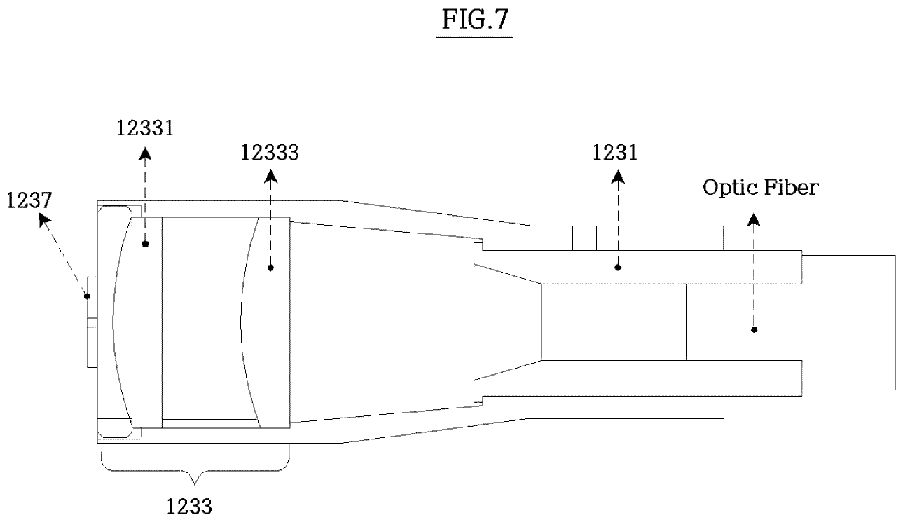

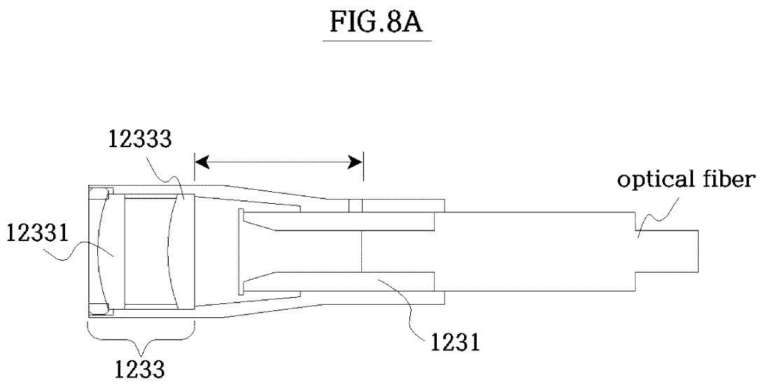

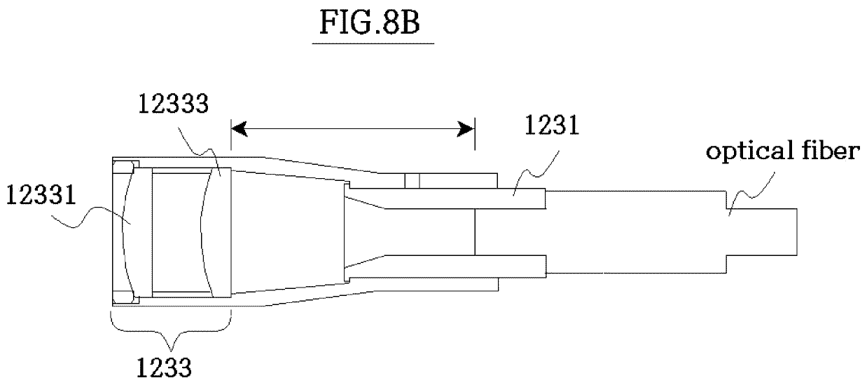

FIG. 7 is an exemplary view of a configuration of the light radiating part of the apparatus for examining a lens flare according to the present disclosure, and FIG. 8A and FIG. 8B are exemplary views of a concept that a distance between a fastening part and a light condensing part of the light radiating part changes.

FIG. 7 shows a cross-section of the light radiating part 123, illustrating the fastening part 1231 to which the optical cable is fastened by being inserted thereinto, the light condensing part 1233 including a first light condensing lens 12331 and a second light condensing lens 12333, the pin hole part 1237 through which the condensed spot light is output, and a space that is a predetermined separation distance between the fastening part 1231 and the light condensing part 1233.

At this time, the fastening part 1231 may be moved so that the separation distance between the fastening part 1231 and the light condensing part 1233 is changed. FIG. 8A and FIG. 8B illustrate such a concept. FIG. 8A illustrates a state in which the fastening part 1231 is moved as close as possible to the light condensing part 1233, FIG. 8B illustrates a state in which the fastening part 1231 is moved as far as possible from the light condensing part 1233, and in this example, due to a difference in a separation distance, a field of view (FOV) of light passing through the light condensing part may be changed by about 2°.

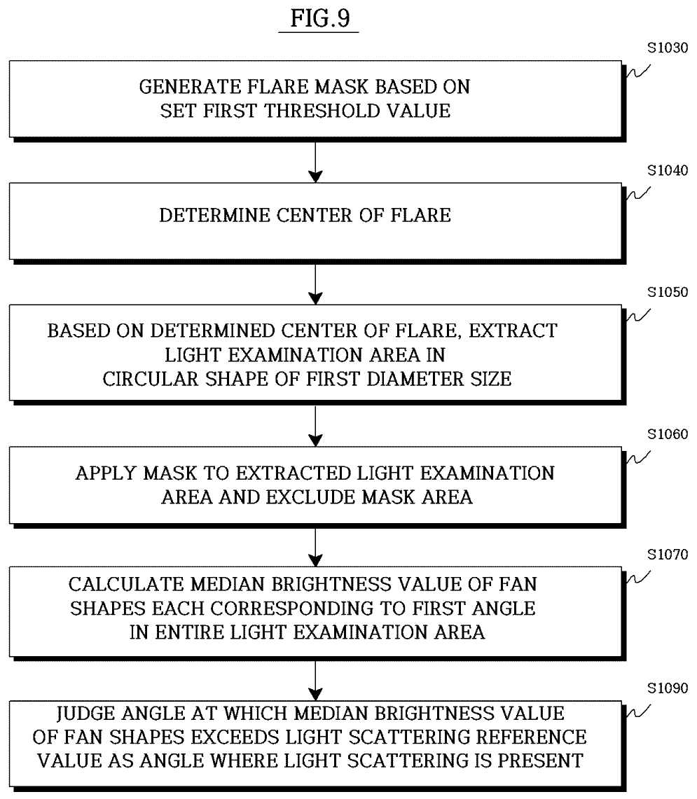

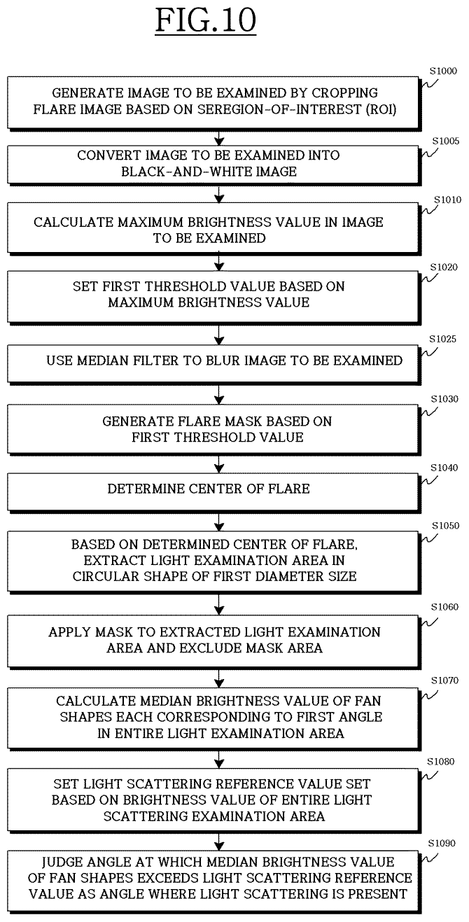

FIG. 9 is a flowchart of a method for examining a flare according to one aspect of the present disclosure, and FIG. 10 is a flowchart of a method for examining a flare according to an additional aspect of the present disclosure. The method for examining a flare according to one aspect of the present disclosure includes an image cropping step, a flare mask generating step, a flare mask applying step, a median brightness value calculating step, a light scattering reference value setting step, and a light scattering judging step.

According to an additional aspect of the present disclosure, the method for examining a flare may further include an image cropping step and/or a light scattering reference value setting step.

The method for examining a flare according to the present disclosure is a method for examining a flare that is performed in the above-described image processing part including one or more processors and a memory storing program instructions executable by the processors. A flare image examination apparatus at this time includes a software concept in addition to a hardware concept. The flare image examination apparatus may be a computer apparatus that, in addition to the processors and the memory, further includes a GPU, a storage device, a display, an input device, etc. The processors are processors executing program instructions, and the memory is connected to the processors and stores program instructions executable by the processors, data to be used by the processors in an arithmetic operation, data processed by the processors, etc.

The image cropping step, the flare mask generating step, the flare mask applying step, the median brightness value calculating step, the light scattering reference value setting step, and the light scattering judging step may be implemented as a set of computer program instructions of which at least some of the functions are executed by the processors of the flare image examination apparatus.

The image cropping step is a step of, from an image capturing one or more spot light sources, generating an image to be examined by cropping an image area including a flare based on a set region-of-interest (ROI) (S1000).

The flare examination apparatus includes a plurality of spot light sources and radiates spot light to various positions on a lens located in a flare examination area. At this time, the positions of the spot light sources may be adjusted to vary according to a camera module being examined, and an ROI may be set by the flare image examination apparatus according to the positions of the spot light sources. The flare examination apparatus is an apparatus including the flare image examination apparatus to examine a lens.

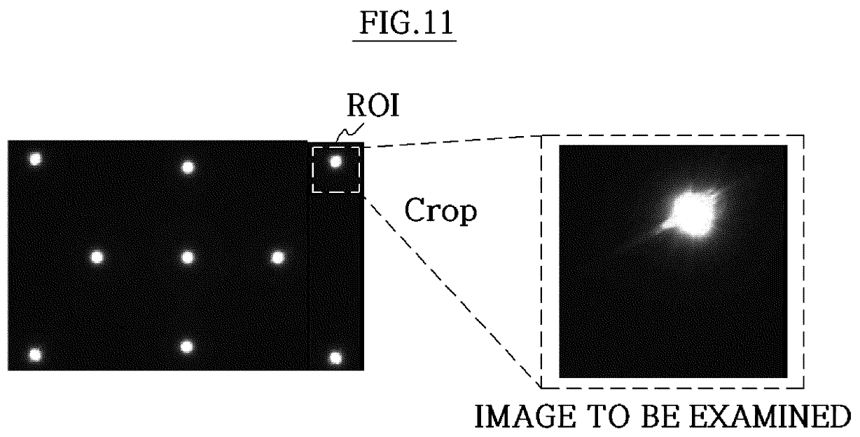

FIG. 11 illustrates a concept of generating an image to be examined in the method for examining a flare and illustrates nine flares of which images are captured using nine spot light sources. As an example of the image cropping of FIG. 10, the image of the flare at the upper right side is cropped as a corresponding ROI. The flare examination method according to the present disclosure is performed for each of the nine flares illustrated in FIG. 11.

FIG. 11 illustrates an example in which nine spot light sources are used, but the number of spot light sources is not limited, and only one spot light source may be used. In this case, the flare image examination apparatus uses an input image as an image to be examined without a need to perform the image cropping step.

The flare mask generating step is a step of, by the flare image examination apparatus, detecting a flare based on a pixel brightness from an image to be examined and generating a flare mask in an area consisting of pixels having a brightness value greater than or equal to a first threshold value set according to a maximum brightness value of pixels in the flare (S1030).

Since the flare examination apparatus shines the spot light source on the lens, only the pixels corresponding to the flares have a brightness value, and the rest of the pixels have a brightness value of 0. Generally, the brightness value ranges from 0 to 255.

When extracting a flare area from an image to be examined, the flare image examination apparatus extracts the flare area using pixels having predetermined brightness or more, that is, a brightness value greater than or equal to the first threshold value set to a predetermined ratio with respect to the maximum brightness value, and generates the extracted corresponding area as a flare mask.

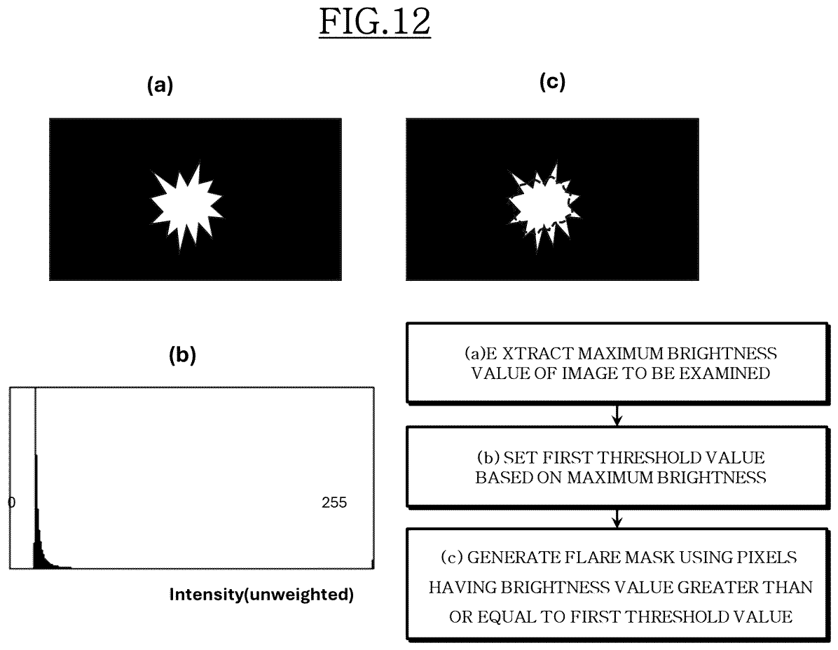

FIG. 12 illustrates a concept of generating a flare mask in the method for examining a flare according to one aspect of the present disclosure. Specifically, the flare mask generating step includes a maximum brightness value calculating step and a mask generating step.

According to an additional aspect of the present disclosure, the flare mask generating step of the flare examination method may further include a first threshold value setting step.

The maximum brightness value calculating step, the first threshold value setting step, and the mask generating step may be implemented as a set of computer program instructions of which at least some of the functions are executed by the processors of the flare image examination apparatus.

The maximum brightness value calculating step is a step of obtaining a maximum brightness value of pixels in the image to be examined (S1010). Although the flare image inspection apparatus obtains the maximum brightness value based on all the pixels, in reality, when the maximum brightness value is obtained from a central area of the flare and the corresponding brightness is 255, the obtaining of the maximum brightness value may stop without being performed further even when there are remaining pixels.

The first threshold value may be set as an arbitrary value by a user. However, the present disclosure is not limited thereto, and the first threshold value may be automatically set based on the maximum brightness value of the image to be examined.

The first threshold value setting step is a step of, by the flare image examination apparatus, setting the first threshold value by multiplying the maximum brightness value by a scale factor set to a value less than 1 (S1020). For example, the flare image examination apparatus may set the scale factor to 0.8.

The mask generating step is a step of, by the flare image examination apparatus, generating the flare mask in the area consisting of the pixels having the brightness value greater than or equal to the set first threshold value (S1030).

In FIG. 12, an area of the flare that is shown in dotted line corresponds to a flare mask.

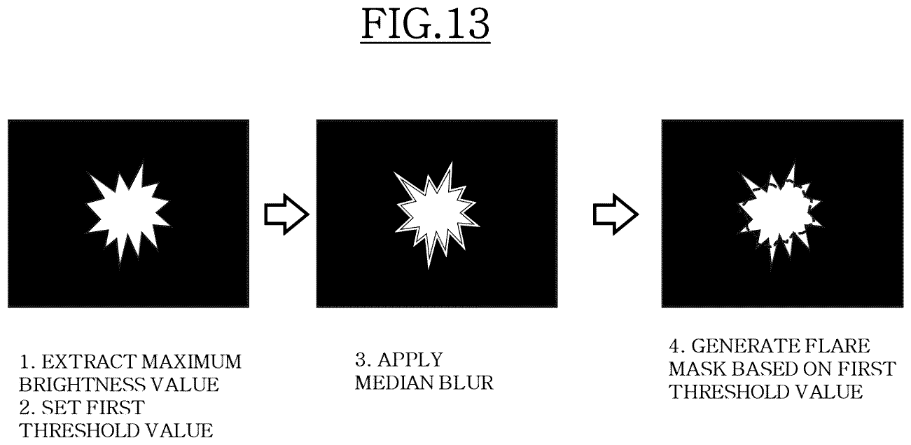

FIG. 13 illustrates a concept of generating the flare mask after applying a median blur according to an additional aspect of the present disclosure. According to an additional aspect of the present disclosure, the flare mask generating step of the flare examination method may further include a blurring step of, before the generating of the mask, using a median filter to blur the image to be examined (S1025).

The blurring step may be implemented as a set of computer program instructions of which at least some of the functions are executed by the processors of the flare image examination apparatus.

As illustrated in FIG. 13, after applying a blur using a median filter, that is, a median blur, the flare mask may be generated using the pixels having the brightness value greater than or equal to the first threshold value. The flare mask of FIG. 13 is generated with a smoother boundary surface than the mask illustrated in FIG. 12.

The flare mask applying step is a step of, by the flare image examination apparatus, extracting a light scattering examination area having a circular shape of a set first diameter size from the image to be examined (S1050) and applying the flare mask.

Applying the flare mask means causing the brightness value of an area corresponding to the flare mask in the image of the light scattering examination area to be 0, that is, applying the flare mask on a light examination area to exclude the corresponding mask area (S1060).

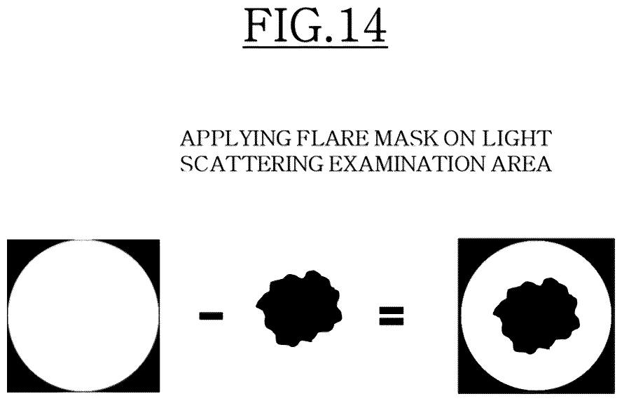

FIG. 14 illustrates a concept of applying the flare mask in the method for examining a flare. Specifically, the flare mask applying step includes a flare center determining step, an examination area extracting step, and a mask applying step.

The flare center determining step, the examination area extracting step, and the mask applying step may be implemented as a set of computer program instructions of which at least some of the functions are executed by the processors of the flare image examination apparatus.

The flare center determining step is a step of, by the flare image examination apparatus, determining a center of the detected flare (S1040). The center of the flare may be determined as a median value of coordinates of positions of pixels detected in the flare, but the present disclosure is not limited thereto, and another method may be used to determine the center.

The examination area extracting step is a step of, by the flare image examination apparatus, based on the determined center of the flare, extracting the light scattering examination area in the circular shape of the set first diameter size from the image to be examined (S1050). That is, the flare image examination apparatus forms a circle having the first diameter size with the determined center of the flare as the center of the circle and selects the light scattering examination area.

The mask applying step is a step of, by the flare image examination apparatus, applying the flare mask on the extracted light scattering examination area so that a brightness of the area of the mask becomes 0. As illustrated in FIG. 14, an area of the flare mask is excluded from the flare so that the area corresponding to the flare mask in the flare is shown in black (brightness value of 0) in the light scattering examination area (S1060).

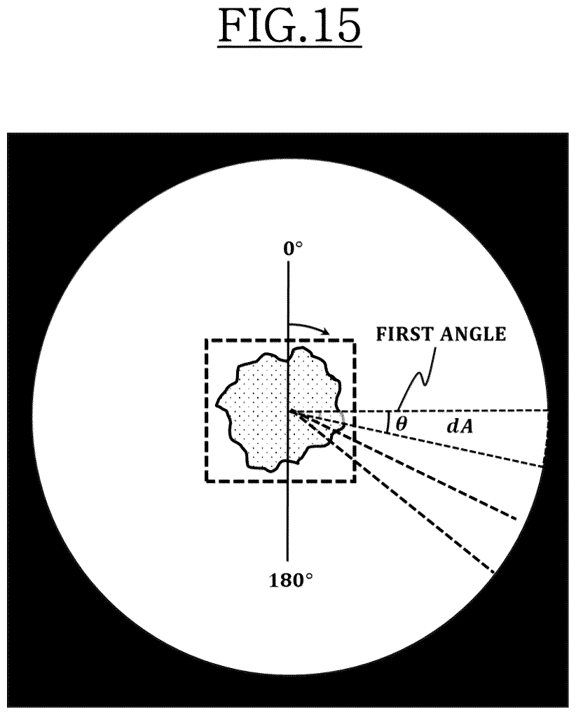

FIG. 15 illustrates a concept of setting a light scattering reference value in the method for examining a flare.

The median brightness value calculating step is a step of, by the flare image examination apparatus, obtaining a median brightness value of fan shapes each having a first angle set based on a center of the light scattering examination area, wherein the median brightness value of the fan shapes each having the first angle is obtained while the fan shapes each having the first angle rotate throughout the entire light scattering examination area (S1070).

According to aspects of the disclosure, the flare image examination apparatus may, in the median brightness value calculating step, obtain the median brightness value of the fan shapes each having the first angle based on 360° while the fan shapes each having the first angle rotate without overlapping.

For a circle corresponding to the light scattering examination area, the flare image examination apparatus increases an angle from a set reference line (e.g., a line corresponding to the y-axis based on the center of the circle) by a set angle or a first angle each time, obtains brightness values of pixels belonging to an area dA of the fan shape corresponding to the current angle, and obtains a median of these brightness values.

The number of times the median value corresponding to the fan shapes is obtained is determined according to the first angle and an angle increase due to each rotation. For example, when the first angle is set to 1°, and the fan shapes do not overlap, the median brightness value corresponding to a total of 360 fan shapes is calculated. When the fan shapes do not overlap, the first angle should be set to a value corresponding to a divisor of 360, and although the first angle may be arbitrarily set, preferably, the first angle may be set to 1° to increase angular resolution.

According to aspects of the disclosure, the median value corresponding to the fan shapes may be obtained while the fan shapes rotate and overlap each other. For example, the first angle may be set to 2°, and an angle increase due to each rotation may be set to 1°.

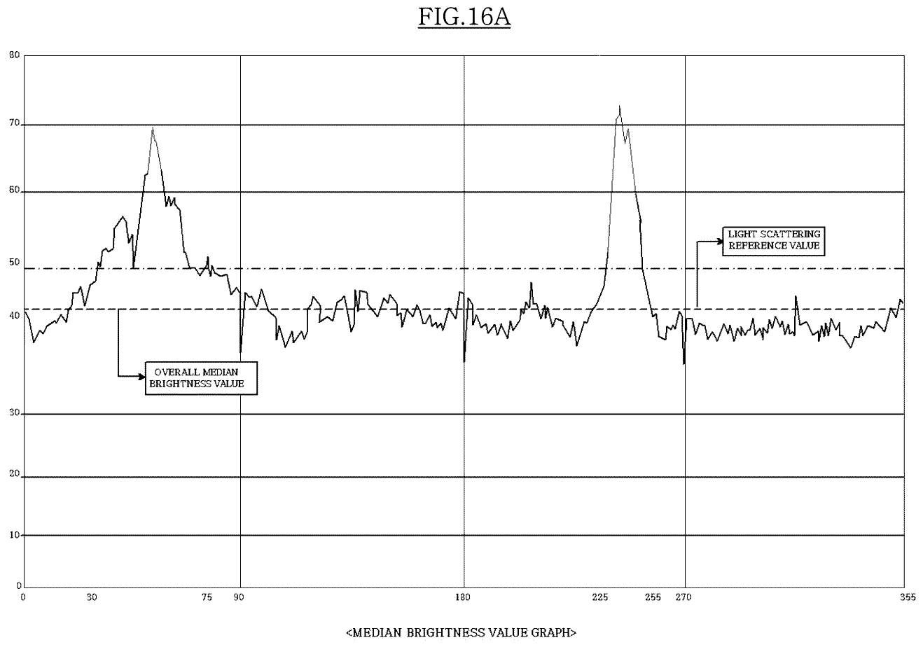

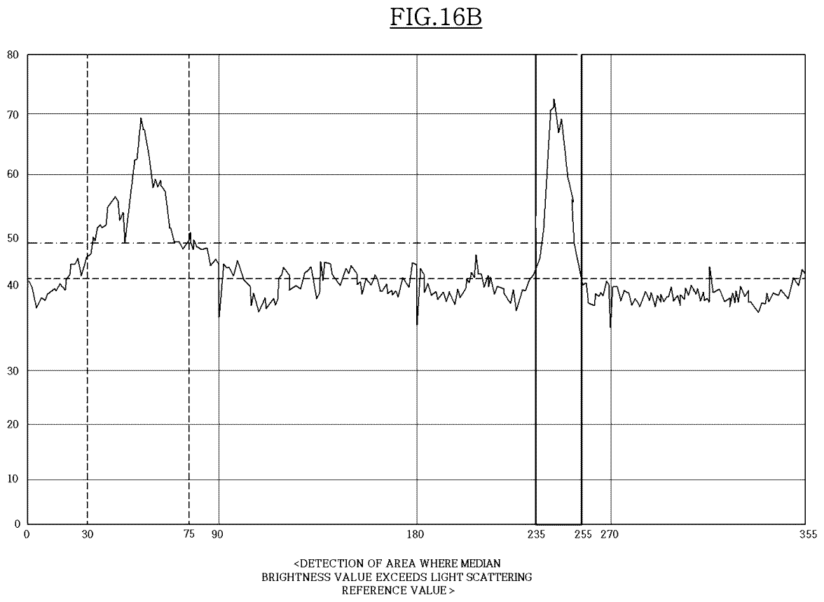

FIG. 16A and FIG. 16B illustrate a concept of judging light scattering in the method for examining a flare.

The light scattering reference value may be set as an arbitrary value by a user. However, the present disclosure is not limited thereto, and the light scattering reference value may be automatically set using the median brightness value of all the fan shapes.

The light scattering reference value setting step for automatically setting the light scattering reference value is a step of, by the flare image examination apparatus, obtaining the median brightness value of all the fan shapes each having the first angle and then multiplying the median brightness value by a set second threshold value to set the light scattering reference value (S1080).

The flare image examination apparatus obtains the median brightness value of the entire light scattering examination area using the median brightness value of the fan shapes that is obtained in the median brightness value calculating step. The flare image examination apparatus multiplies the median brightness value of the light scattering examination area by the second threshold value greater than 1 to set the light scattering reference value.

The light scattering judging step is a step of, by the flare image examination apparatus, judging an angle at which the median brightness value of all the fan shapes each having the first angle exceeds the light scattering reference value as an angle where light scattering is present (S1090).

In FIG. 16A and FIG. 16B, an area corresponding to a median brightness value of the fan shapes each having the first angle that exceeds the light scattering reference value is an area judged as an angle where light scattering is present.

According to aspects of the disclosure, the flare image examination apparatus may mark the angle where light scattering is present on the image to be examined and may display a flare image judged as having light scattering.

According to an additional aspect of the present disclosure, the flare examination method may further include a black-and-white image conversion step.

The black-and-white image conversion step may be implemented as a set of computer program instructions of which at least some of the functions are executed by the processors of the flare image examination apparatus.

The black-and-white image conversion step is a step of converting the image to be examined into a black-and-white image, that is, a gray scale image (S1005). Since the flare examination method of the present disclosure uses brightness values of pixels, the image to be examined may be converted into a black-and-white image and used.

According to the present disclosure, from an image including a flare artificially generated using a spot light source, an image of the flare can be analyzed, and a light scattering defect of a lens can be automatically judged.

Various embodiments disclosed in this specification and drawings only present specific examples to help understanding, and it is not intended to limit the scope of various embodiments of the present disclosure.

Therefore, in addition to the embodiments described herein, all changes or modifications derived based on the technical spirit of various embodiments of the present disclosure should be construed as being included in the scope of various embodiments of the present disclosure.

What is claimed is:

1. An apparatus for examining a lens flare, the apparatus comprising:
a camera module fixing part fixing a camera module to be examined to an examination position;
an optical part including one or more light source parts, one or more light radiating parts condensing light input from the light source parts and radiating spot light, and a mounting part mounting the one or more light radiating parts on an upper portion of the camera module fixing part such that the spot light radiated by the light radiating parts reaches a lens of the camera module; and
an image processing part examining a lens flare in an image obtained through the camera module fixed on the camera module fixing part.

2. The apparatus of claim 1, wherein the image processing part includes one or more processors and a memory storing program instructions executable by the processors, and the program instructions include:
a set of flare mask generating instructions for detecting a flare based on a pixel brightness from an image to be examined and generating a flare mask in an area having a brightness value greater than or equal to a first threshold value set according to a maximum brightness value of pixels in the flare;
a set of flare mask applying instructions for extracting a light scattering examination area having a circular shape of a set first diameter size from the image to be examined and applying the flare mask;
a set of median brightness value calculating instructions for obtaining a median brightness value of fan shapes each having a first angle set based on a center of the light scattering examination area, wherein the median brightness value of the fan shapes each having the first angle is obtained while the fan shapes each having the first angle rotate throughout the entire light scattering examination area; and
a set of light scattering judging instructions for judging an angle at which the median brightness value of the fan shapes each having the first angle exceeds a light scattering reference value as an angle where light scattering is present.

3. The apparatus of claim 2, wherein the program instructions of the image processing part further include a set of image cropping instructions for, from an image capturing one or more spot light sources, generating the image to be examined by cropping an image area including the flare based on a set region-of-interest (ROI).

4. The apparatus of claim 2, wherein the program instructions of the image processing part further include a set of light scattering reference value setting instructions for obtaining the median brightness value of all the fan shapes each having the first angle and then multiplying the median brightness value by a set second threshold value to set the light scattering reference value.

5. The apparatus of claim 2, wherein the set of the flare mask generating instructions includes:
a set of maximum brightness value calculating instructions for obtaining a maximum brightness value of pixels in the image to be examined; and
a set of mask generating instructions for generating the flare mask in an area where the brightness value is greater than or equal to the set first threshold value.

6. The apparatus of claim 5, wherein the set of the flare mask generating instructions further includes a set of first threshold value setting instructions for setting the first threshold value by multiplying the maximum brightness value by a scale factor set to a value less than 1.

7. The apparatus of claim 5, wherein the set of the flare mask generating instructions further includes a set of blurring instructions for, before the generating of the mask, using a median filter to blur the image to be examined.

8. The apparatus of claim 2, wherein the set of the flare mask applying instructions includes:
a set of flare center determining instructions for determining a center of the detected flare;
a set of examination area extracting instructions for, based on the determined center of the flare, extracting the light scattering examination area in the circular shape of the set first diameter size from the image to be examined; and
a set of mask applying instructions for applying the flare mask on the extracted light scattering examination area so that a brightness of the area of the mask becomes 0.

9. The apparatus of claim 2, wherein the program instructions of the image processing part further include a set of black-and-white image conversion instructions for converting the image to be examined into a black-and-white image.

10. The apparatus of claim 1, wherein the optical part further includes an adjusting part adjusting positions of the light radiating parts mounted on the mounting part and adjusting light radiation directions of the light radiating parts.

11. The apparatus of claim 1, wherein:
the optical part further includes an optical cable guiding the light output from the light source parts to the light radiating parts; and
the light radiating parts each include a fastening part fastened to the optical cable to receive light, a light condensing part including one or more light condensing lenses spaced a predetermined distance from the fastening part and condensing light input through the fastening part, and a light output part outputting the condensed light.

12. The apparatus of claim 11, wherein the optical part further includes a pin hole part coupled to the light output part to allow the light to be output in a circular shape or a polygonal shape.

13. The apparatus of claim 11, wherein the fastening part is moved so that a separation distance between the fastening part and the light condensing part is changed.

14. A method for examining a flare that is performed by a lens flare examination apparatus including a camera module fixing part fixing a camera module to be examined to an examination position, an optical part including one or more light source parts generating and outputting light, one or more light radiating parts condensing light input from the light source parts and radiating spot light, and a mounting part mounting the one or more light radiating parts on an upper portion of the camera module fixing part such that the spot light radiated by the light radiating parts reaches a lens of the camera module, and an image processing part examining a lens flare in an image obtained through the camera module fixed on the camera module fixing part and including one or more processors and a memory storing program instructions executable by the processors, the method comprising:
a flare mask generating step of detecting a flare based on a pixel brightness from an image to be examined and generating a flare mask in an area having a brightness value greater than or equal to a first threshold value set according to a maximum brightness value of pixels in the flare;
a flare mask applying step of extracting a light scattering examination area having a circular shape of a set first diameter size from the image to be examined and applying the flare mask;
a median brightness value calculating step of obtaining a median brightness value of fan shapes each having a first angle set based on a center of the light scattering examination area, wherein the median brightness value of the fan shapes each having the first angle is obtained while the fan shapes each having the first angle rotate throughout the entire light scattering examination area; and
a light scattering judging step of judging an angle at which the median brightness value of the fan shapes each having the first angle exceeds a light scattering reference value as an angle where light scattering is present.

15. The method of claim 14, further comprising an image cropping step of, from an image capturing one or more spot light sources, generating the image to be examined by cropping an image area including the flare based on a set region-of-interest (ROI).

16. The method of claim 14, further comprising a light scattering reference value setting step of obtaining the median brightness value of all the fan shapes each having the first angle and then multiplying the median brightness value by a set second threshold value to set the light scattering reference value.

17. The method of claim 14, wherein the flare mask generating step includes:
a maximum brightness value calculating step of obtaining a maximum brightness value of pixels in the image to be examined; and
a mask generating step of generating the flare mask in an area where the brightness value is greater than or equal to the set first threshold value.

18. The method of claim 17, wherein the flare mask generating step further includes a first threshold value setting step of setting the first threshold value by multiplying the maximum brightness value by a scale factor set to a value less than 1.

19. The method of claim 17, wherein the flare mask generating step further includes a blurring step of, before the generating of the mask, using a median filter to blur the image to be examined.

20. The method of claim 14, wherein the flare mask applying step includes:
a flare center determining step of determining a center of the detected flare;
an examination area extracting step of, based on the determined center of the flare, extracting the light scattering examination area in the circular shape of the set first diameter size from the image to be examined; and
a mask applying step of applying the flare mask on the extracted light scattering examination area so that a brightness of the area of the mask becomes 0.
